(19) United States
(12) Patent Application Publication
(10) Pub. No.: US 2023/0205535 A1
(43) Pub. Date: Jun. 29, 2023

(54) OPTIMIZATION OF CAPTURED LOOPS IN A PROCESSOR FOR OPTIMIZING LOOP REPLAY PERFORMANCE

(71) Applicant: Microsoft Technology Licensing, LLC, Redmond, WA (US)

(72) Inventors: Rami Mohammad AL SHEIKH, Morrisville, NC (US); Michael Scott MCILVAINE, Raleigh, NC (US)

(21) Appl. No.: 17/561,006

(22) Filed: Dec. 23, 2021

(51) Int. Cl. G06F 9/38; G06F 9/30

(52) U.S. Cl. CPC G06F 9/381; G06F 9/30065; G06F 9/3836; G06F 9/30079

(57) ABSTRACT

Optimization of captured loops in a processor for optimizing loop replay performance, and related methods and computer-readable media are disclosed. The processor includes a loop buffer circuit configured to detect loops. In response to a detected loop, the loop buffer circuit is configured to capture loop instructions in the detected loop and replay the captured loop instructions in the instruction pipeline to be processed and executed for subsequent iterations of the loop. The loop buffer circuit is configured to determine if loop optimizations are available to be made based on a captured loop to enhance performance of loop replay. If the loop buffer circuit determines loop optimizations are available to be made based on a captured loop, the loop buffer circuit is configured to perform such loop optimizations so that such loop optimizations can be realized when the captured loop is replayed to enhance replay performance of the captured loop.

### FIELD OF THE DISCLOSURE

The technology of the disclosure relates generally to performing loop buffering (i.e., loop detection and replay) for loops in computer software instructions processed in a processor.

### BACKGROUND

Microprocessors, also known as “processors,” perform computational tasks for a wide variety of applications. A conventional microprocessor includes a central processing unit (CPU) that includes one or more processor cores, also known as “CPU cores,” that execute software instructions. The software instructions instruct a CPU to perform operations based on data. The CPU performs an operation according to the instructions to generate a result, which is a produced value. Processors employ instruction pipelining as a processing technique whereby the throughput of instructions being executed by a processor may be increased by splitting the handling of each instruction into a series of steps. These steps are executed in one or more instruction pipelines each composed of multiple stages in an instruction processing circuit. In this regard, an instruction processing circuit in a processor includes an instruction fetch circuit that is configured to fetch instructions to be executed from an instruction memory (e.g., system memory or an instruction cache memory). The fetched instructions are decoded in a decoding state and inserted into an instruction pipeline to be pre-processed before reaching an execution circuit to be executed.

Many modern high-performance processors deploy a loop buffer for further pipeline optimization and power savings. A loop is defined as any sequence of instructions in the pipeline whose processing is repeated sequentially in back-to-back operations. For example, loops can occur based on programming software loop constructs that are then compiled in instructions that, according to their processing, will cause a loop operation. FIG. 1 illustrates an example of an instruction stream 100 of instructions that includes an example loop 102. The loop 102 is a “while” loop that begins with a while instruction 104 that has a condition that is evaluated when processed. Instructions 106-112 in the loop 102 are executed and continue to be executed in a loop if the condition of the while instruction 104 is evaluated as true. The loop 102 is exited from the while instruction 104 as an exit branch instruction, to a next instruction 114 at an exit target address, in response to the condition of the while instruction 104 being evaluated as false. If a loop, such as the loop 102 in FIG. 1, can be detected in a pipeline, the instructions in the loop can be captured and replayed for the number of iterations the loop is processed before exiting without having to re-fetch and re-decode such instructions. This is because the loop involves the same sequence of instructions that will have already been fetched and decoded for the first iteration of the loop. In this manner, the fetch and decode stages of the pipeline can be de-activated or otherwise stalled to conserve power in the pipeline if a loop can be detected and replayed.

In this regard, many processors include a loop buffer in its instruction pipeline that includes a loop detection circuit and a loop replay circuit. The loop detection circuit is configured to identify a repeated sequence of instructions in an instruction stream processed in an instruction pipeline to detect a loop. In response to detection of a loop, a loop capture circuit is configured to capture the sequence of instructions in the detected loop in a loop buffer. A loop replay circuit is then configured to replay such captured instructions from the loop buffer in the instruction pipeline for the defined number of loop iterations (called “trip count”) or indefinitely, depending on design, without such captured instructions having to be re-fetched and re-decoded. The fetch and decoding stages of the instruction pipeline can be restarted once the loop is exited to then start conventional fetching and decoding instructions starting from the end of the detected loop.

It is also conventional for optimizations to be performed in program code that is to be executed in a processor to enhance operational performance. Performing code optimizations for instructions in loops may be particularly advantageous, because the performance benefit of such code optimizations can be realized with each iteration of the loop in a processor. At compile time, a compiler can analyze instructions in program code to perform certain code optimizations to the instructions in program code to enhance performance. For example, a compiler may be able to condense certain instructions into less instructions or instructions that can be executed in less clock cycles to optimize operational performance. The optimized instructions can then be compiled into the executable binary program code that will be executed by a processor. The compiler has the visibility of all instructions in the program code to make such code optimizations. However, a compiler may not have access to run time information that is generated during the actual execution of the instructions in the program code. For example, the program code can include conditional branch instructions that cause one of a number of different instruction flow paths to be taken depending on the outcome of the condition specified in the conditional branch instruction. The execution of conditional branch instructions can result in loops for example. Loop exits can also be controlled by conditional branch instructions. Additional code optimizations may be able to be performed with run-time knowledge of actual instruction flow paths resulting from processing of conditional branch instructions in an instruction pipeline. However, the processor only has knowledge of the instructions present in the instruction pipeline at any given time. The processor does not have knowledge of instructions that have not yet been fetched. This limited visibility can negatively affect the ability of the processor to perform certain code optimizations that would require additional knowledge of instructions that have not yet been fetched into the instruction pipeline. Further, in the example of code optimizations for a loop, the instructions that form the loop can be spread across different pipeline stages of the instruction pipeline that make it impossible or infeasible to perform code optimizations for the loop.

### SUMMARY

Exemplary aspects disclosed herein include optimization of captured loops in a processor for optimizing loop replay performance Related methods and computer-readable media are also disclosed. The processor includes an instruction processing circuit configured to fetch computer program instructions (“instructions”) into an instruction stream in an instruction pipeline(s) to be processed and executed. Loops can be contained in the instruction stream. A loop is a sequence of instructions in the instruction stream that repeat sequentially in a back-to-back arrangement. The instruction processing circuit includes a loop buffer circuit that is configured to detect loops. In response to a detected loop, the loop buffer circuit is configured to capture loop instructions in the detected loop and insert (i.e., replay) the captured loop instructions in the instruction pipeline to be processed and executed for subsequent iterations of the loop. In this manner, the instructions in the loop may have not have to be re-fetched and re-processed, for example, for the subsequent iterations of the loop. In exemplary aspects, the loop buffer circuit is also configured to determine if loop optimizations are available to be made based on a captured loop to enhance performance of the replay of the loop, and to perform such loop optimizations if available. Because the captured loop may contain more instructions for a captured loop than would otherwise be present in the instruction pipeline or a particular pipeline stage for processing at a given time, the processor can use this enhanced visibility of a larger number of instructions in a loop captured in the loop buffer circuit to determine loop optimizations for the loop. These loop optimizations may not be possible to determine otherwise at compile time and/or at run-time based only on the knowledge of the presence of certain instructions of the loop within the instruction pipeline. In this regard, if the loop buffer circuit determines that if loop optimizations are available to be made based on a captured loop, the loop buffer circuit is configured to modify at least one instruction in the captured loop to produce an optimized loop. The optimized loop can then be replayed in the instruction pipeline when the loop is to be re-processed and re-executed in the instruction pipeline in an iteration(s) so that the loop optimization is realized by the processor.

In one exemplary aspect, the loop buffer circuit includes a loop optimization circuit that is configured determine a loop optimization(s) for a captured loop by performing a loop post-capture instruction transformation analysis of the instructions in the captured loop. The loop post-capture instruction transformation analysis determines if any such instructions can be transformed (e.g., modified, merged, removed outside of loop) to affect a loop optimization(s) when the captured loop is replayed. If the loop post-capture instruction transformation analysis determines instructions can be transformed to affect a loop optimization(s), such instructions are transformed by the loop buffer circuit so that such loop optimization(s) are realized when the transformed instructions are replayed as part of replaying a captured loop. For example, the loop buffer circuit can be configured to determine if any instructions in a captured loop can be fused (i.e., merged or combined) into less or a single instruction to be inserted in the instruction pipeline when the loop is replayed. This allows the captured loop to be replayed with processing of less instructions than in the originally captured loop. For example, a producer instruction in the captured loop that is identified as having a target operand that is a source operand of a younger consumer instruction can be merged with the consumer instruction to reduce the number of instructions in the loop for a replayed iteration of the captured loop. In this manner, the loop buffer circuit is able to merge instructions in a loop that may otherwise not be identifiable if such merged instructions were separated by a sufficient code distance to not be present and/or identifiable within pipeline stages in the instruction pipeline. The loop buffer circuit can be configured to identify instructions that can be merged both within the same replayed iteration of a loop as well as across different iterations (i.e., cross-iteration) of a replayed loop.

In another exemplary aspect, the loop buffer circuit includes a loop optimization circuit that is configured to perform a loop post-capture instruction transformation analysis of the instructions in the captured loop by detecting if any instructions are loop invariant such that the instruction generates the same result for each replay iteration of the captured loop. If so, this means such loop invariant instruction can be transformed to be moved by the loop buffer circuit outside of the captured loop and replayed only once regardless of the number of times the captured loop is replayed as a loop optimization. An example of such an instruction is an instruction that produces a constant value. In another exemplary aspect, the loop buffer circuit is configured to perform a loop post-capture analysis of the instructions in the captured loop to detect if any instructions can be transformed to other instruction(s) that have a reduced instruction strength, meaning that it would take a reduced number of clock cycles to execute to generate the same results for the operation. An example of such an instruction is a multiply instruction that multiples a source by two (2). In this example, the multiply instruction can be transformed and replaced with an instruction that left shifts the value of the source by one bit as an instruction that takes less clock cycles to execute. In this manner, the replay of the captured loop will replay such transformed instructions that take less clock cycles to process and execute than the original instruction in the captured loop.

In another exemplary aspect, the loop buffer circuit includes a loop optimization circuit that is configured to perform a loop post-capture instruction transformation analysis of the instructions in the captured loop to detect critical-timing instructions. The loop buffer circuit is configured to transform such identified critical instructions with scheduling hints that can be used by a scheduling circuit in the instruction pipeline to prioritize their issuance for execution when replayed. For example, instructions in the captured loop that are identified as performing critical loads are critical instructions whose timing affects other dependent instructions and can be transformed with a scheduling hint so that these instructions are scheduled for execution earlier in replay. An example of a critical load instruction is a load instruction whose produced result is consumed by a conditional branch instruction. The produced results of the load instruction are necessary to resolve the prediction of the conditional branch instruction. Thus, if the conditional branch instruction, an earlier replay and execution of the critical load instruction can result in a faster resolution of the mispredicted conditional branch instruction. Another example of a critical instruction that can benefit from scheduling hints are instructions identified as having dependence chains within a captured loop and marking key unlocking instructions are critical.

In another exemplary aspect, the loop optimization circuit is configured determine a loop optimization(s) for a captured loop by performing a loop post-capture instruction analysis of the instructions in the captured loop to identify any instruction execution slices. An instruction execution slice in a captured loop is a set of instructions in the captured loop that compute load/store memory addresses needed for memory load/store instructions to be executed in replay of the captured loop. Memory loads and stores within a replayed loop that result in a cache miss result in a performance penalty in instruction pipeline throughput when the loop is replayed. However, memory loads and stores within a replayed loop that more frequently result in cache misses may result in an enhanced performance penalty in instruction pipeline throughput as a function of the number of its replay iterations. Thus, in this example, the loop buffer circuit can be configured to extract an identified instruction execution slice identified in the instructions of the captured loop. The loop buffer circuit is configured to convert an identified extracted instruction execution slice into a software prefetch instruction(s) that can then be injected into a pre-fetch stage(s) in the instruction pipeline when the captured loop is replayed to perform the loop optimization for the captured loop. The processing of the software prefetch instruction(s) for the instruction execution slice will cause the instruction processing circuit of the processor to perform the extracted instructions in the instruction execution slice earlier in the instruction pipeline as pre-fetch instructions. Thus, any resulting cache misses from the memory operations performed by processing the extracted execution slice instructions as pre-fetch instructions can be recovered earlier for consumption by the dependent instructions when the captured loop is replayed. The extracted instruction execution slice can be stored in a separate buffer apart from the loop buffer circuit or within the loop buffer circuit with a special identifier (e.g., with extra pointer bits) to be used to generate the software prefetch instruction(s) as examples.

In this regard, in one exemplary aspect a processor is provided. The processor comprising an instruction processing circuit configured to process an instruction stream comprising a plurality of instructions in an instruction pipeline. The instruction processing circuit comprises a loop buffer circuit. The loop buffer circuit is configured to detect a loop comprising a plurality of loop instructions among the plurality of instructions in the instruction stream. In response to detection of the loop in the instruction stream, the loop buffer circuit is configured to capture the plurality of loop instructions of the detected loop as a captured loop. The loop buffer circuit is configured to determine, based on the captured loop, if a loop optimization is available to be made for the captured loop. In response to determining the loop optimization is available to be made for the captured loop, the loop buffer circuit is configured to modify the captured loop to produce an optimized loop. The loop buffer circuit is also configured determine if the captured loop is to be replayed in the instruction pipeline. In response to determining the captured loop is to be replayed in the instruction pipeline, the loop buffer circuit is configured to insert the optimized loop in the instruction pipeline to be replayed.

In another exemplary aspect, a method of replaying an optimized loop based on a captured loop in an instruction pipeline in a processor. The method comprises detecting a loop comprising a plurality of loop instructions among the plurality of instructions in an instruction stream comprising a plurality of instructions in an instruction pipeline. The method also comprises, in response to detection of the loop in the instruction stream capturing the plurality of loop instructions of the detected loop as a captured loop, determining, based on the captured loop, if a loop optimization is available to be made for the captured loop; and modifying the captured loop to produce an optimized loop, in response to determining the loop optimization is available to be made for the captured loop. The method also comprises determining if the captured loop is to be replayed in the instruction pipeline. The method also comprises inserting the optimized loop in the instruction pipeline to be replayed, in response to determining the captured loop is to be replayed in the instruction pipeline.

In another exemplary aspect, a non-transitory computer-readable medium of having stored thereon computer executable instructions which, when executed by a processor, cause the processor to replay an optimized loop based on a captured loop in an instruction pipeline in a processor, by causing the processor to: detect a loop comprising a plurality of loop instructions among the plurality of instructions in an instruction stream comprising a plurality of instructions in an instruction pipeline; in response to detection of the loop in the instruction stream: capture the plurality of loop instructions of the detected loop as a captured loop; determine, based on the captured loop, if a loop optimization is available to be made for the captured loop; and modify the captured loop to produce an optimized loop, in response to determining the loop optimization is available to be made for the captured loop; determine if the captured loop is to be replayed in the instruction pipeline; and insert the optimized loop in the instruction pipeline to be replayed, in response to determining the captured loop is to be replayed in the instruction pipeline.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a diagram of an exemplary loop of computer program instructions in an instruction stream;

FIG. 2 is a diagram of an exemplary processor that includes an exemplary instruction processing circuit that includes one or more instruction pipelines for processing computer instructions for execution, and wherein the processor further includes a loop buffer circuit configured to detect and capture loops in the instruction stream in an instruction pipeline, and determine if a loop optimization(s) is available to be made based on a captured loop to enhance performance of the replay of the loop, and to replay optimized loops based on the captured loops with such loop optimization(s) in the instruction pipeline;

FIG. 3 is a diagram of an exemplary loop buffer circuit that can be provided in the instruction processing circuit in FIG. 2, that includes a loop detection circuit configured to detect loops in the instruction stream in an instruction pipeline, a loop capture circuit configured to capture instructions for a detected loop, a loop optimization circuit configured to identify and perform a loop optimization based on the captured loop, and a loop replay circuit configured to replay optimized loops based on the captured loops with such loop optimization(s) in the instruction pipeline;

FIG. 4 is a flowchart illustrating an exemplary process of the loop buffer circuit in the processor in FIG. 2 capturing detected loops and effectuating a determined loop optimization(s) available to be made based on a captured loop to enhance performance of the replay of an optimized loop in an instruction pipeline of a processor;

FIG. 5A is a diagram of an exemplary captured loop of computer program instructions that includes an available instruction fusion loop optimization that can be identified and realized by transforming instructions in the captured loop;

FIG. 5B is a diagram of an optimized loop of the captured loop in FIG. 5A that includes transformed instructions to provide an instruction fusion loop optimization to the captured loop;

FIG. 6 is a flowchart illustrating an exemplary process of the loop buffer circuit in the processor in FIG. 2 capturing detected loops and effectuating a determined loop optimization(s) by transforming an instruction(s) in the captured loop to produce an optimized loop for replay to enhance performance of the replay of the captured loop in an instruction pipeline of a processor;

FIG. 7A is a diagram of an exemplary captured loop of computer program instructions that includes an available instruction sequence loop optimization that can be identified and realized by transforming instructions in the captured loop;

FIG. 7B is a diagram of an optimized loop of the captured loop in FIG. 7A with transformed instructions to provide an instruction sequence loop optimization to the captured loop;

FIG. 8A is a diagram of an exemplary captured loop of computer program instructions that includes an available critical instruction loop optimization that can be identified and realized by transforming instructions in the captured loop;

FIG. 8B is a diagram of an optimized loop of the captured loop in FIG. 8A with transformed instructions to provide a critical instruction loop optimization to include scheduling hints for critical instructions to the captured loop;

FIG. 9A is a diagram of an exemplary captured loop of computer program instructions that includes an instruction execution slice that can be identified and realized by generating and injecting software pre-fetch instructions representing the instruction execution slice in a pre-fetch stage of an instruction pipeline;

FIG. 9B is a diagram of an optimized loop of the captured loop in FIG. 9A with the detected instruction execution slice in the captured loop removed from the captured loop and converted into software pre-fetch instructions;

FIG. 10 is a diagram of another exemplary loop buffer circuit that can be provided in the instruction processing circuit in FIG. 2, wherein the loop optimization circuit is configured to detect an instruction execution slice in a captured loop and to generate and inject software pre-fetch instructions representing the instruction execution slice in a pre-fetch stage of an instruction pipeline as part of an optimized loop, and wherein the instruction entries in the loop buffer circuit include an execution pointer field configured to identify the instruction as part of an instruction execution slice and to store a pointer identifying a next instruction in the captured loop as part of the detected execution slice instruction in the captured loop;

FIG. 11 is a flowchart illustrating an exemplary process of the loop buffer circuit in FIG. 10, capturing detected loops, detecting an instruction execution slice in the captured loop as an available loop optimization, and generating and injecting software pre-fetch instructions representing the instructions in the detected instruction execution slice in a pre-fetch stage of an instruction pipeline as part of an optimized loop to realize such loop optimization when the captured loop is replayed; and

FIG. 12 is a block diagram of an exemplary processor-based system that includes a processor that includes an instruction processing circuit for executing instructions from program code, and wherein the processor includes a loop buffer circuit, including, but not limited to, the loop buffer circuits in FIGS. 2, 3, and/or 10, configured to detect and capture loops in the instruction stream in an instruction pipeline, and to determine if a loop optimization(s) is available to be made based on a captured loop to enhance performance of the replay of the loop, and to replay optimized loops with such loop optimization(s) in the instruction pipeline.

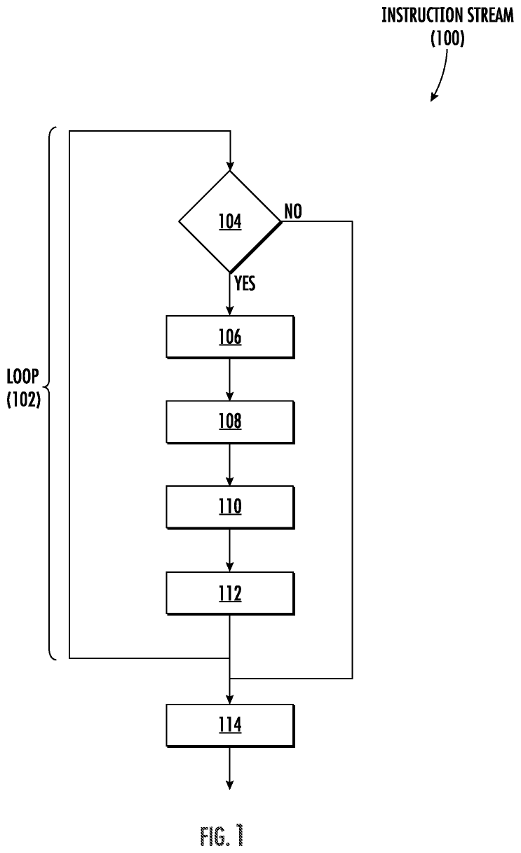

### DETAILED DESCRIPTION

Aspects disclosed herein include optimization of captured loops in a processor for optimizing loop replay performance. Related methods and computer-readable media are also disclosed. The processor includes an instruction processing circuit configured to fetch computer program instructions (“instructions”) into an instruction stream in an instruction pipeline(s) to be processed and executed. Loops can be contained in the instruction stream. A loop is a sequence of instructions in the instruction stream that repeats sequentially in a back-to-back arrangement. The instruction processing circuit includes a loop buffer circuit that is configured to detect loops. In response to a detected loop, the loop buffer circuit is configured to capture loop instructions in the detected loop and insert (i.e., replay) the captured loop instructions in the instruction pipeline to be processed and executed for subsequent iterations of the loop. In this manner, the instructions in the loop may have not have to be re-fetched and re-processed, for example, for the subsequent iterations of the loop. In exemplary aspects, the loop buffer circuit is also configured to determine if loop optimizations are available to be made based on a captured loop to enhance performance of the replay of the loop, and to perform such loop optimizations if available. Because the captured loop may contain more instructions for a captured loop than would otherwise be present in the instruction pipeline or a particular pipeline stage for processing at a given time, the processor can use this enhanced visibility of a larger number of instructions in a loop captured in the loop buffer circuit to determine loop optimizations for the loop. These loop optimizations may not be possible to determine otherwise at compile time and/or at run-time based only on the knowledge of the presence of certain instructions of the loop within the instruction pipeline. In this regard, if the loop buffer circuit determines that, if loop optimizations are available to be made based on a captured loop, the loop buffer circuit is configured to modify at least one instruction in the captured loop to produce an optimized loop. The optimized loop can then be replayed in the instruction pipeline when the loop is to be re-processed and re-executed in the instruction pipeline in an iteration(s) so that the loop optimization is realized by the processor.

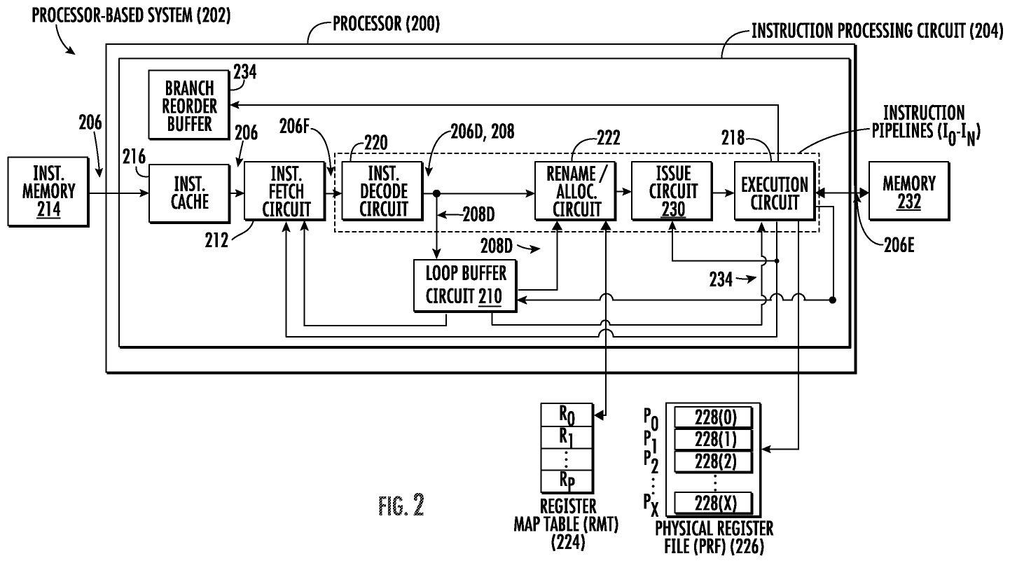

FIG. 2 is a diagram of an exemplary processor 200 in a processor-based system 202 wherein the processor 200 includes an instruction processing circuit 204 configured to process computer instructions 206 in an instruction stream 208 fetched into one or more instruction pipelines I₀-I_{N} for execution. As will be discussed in more detail below, the instruction processing circuit 204 includes a loop buffer circuit 210 that is configured to detect and capture loops in the instruction stream 208. The loop buffer circuit 210 is configured to determine if a loop optimization(s) is available to be made based on a captured loop to enhance performance of the replay of the loop. The loop buffer circuit 210 is configured to replay optimized loops based on the captured loops with such loop optimization(s) in an instruction pipeline I₀-I_{N}. Before discussing exemplary details of the loop buffer circuit 210 in the processor 200 in FIG. 2 detecting and capturing loops in the instruction stream 206 and determining if a loop optimization(s) is available to be made based on a captured loop to enhance performance of the replay of the loop, other aspects of the processor 200 and its instruction processing circuit 204 are first described below.

The processor 200 in FIG. 2 includes an instruction processing circuit 204 that includes a circuit configured to fetch and processes computer program code instructions (referred to as “instructions) to be executed. The instruction processing circuit 204 may be an out-of-order processor as an example. The instruction processing circuit 204 includes an instruction fetch circuit 212 as a pipeline stage configured to fetch instructions 206 from an instruction memory 214. The instruction memory 214 may be provided in or as part of the main memory in the processor-based system 202. An instruction cache 216 may also be provided in the processor-based system 202 to cache the instructions 206 fetched from the instruction memory 214 to reduce timing delays in the instruction fetch circuit 212. The instruction fetch circuit 212 in this example is configured to provide the instructions 206 as fetched instructions 206F into one or more instruction pipelines loop iteration prediction as an instruction stream 208 in the instruction processing circuit 204 to be pre-processed, before the fetched instructions 206F reach an execution circuit 218 as another pipeline stage to be executed. The instruction processing circuit 204 also includes an instruction decode circuit 220 as another pipeline stage that is configured to decode the fetched instructions 206F fetched by the instruction fetch circuit 212 into decoded instructions 206D to determine the instruction type and action required. The instruction type and action required encoded in the decoded instruction 206D may also be used to determine into which instruction pipeline I₀-I_{N} the decoded instructions 206D are placed.

With continued reference to the processor 200 in FIG. 2, once fetched instructions 206F are decoded into decoded instructions 206D by the instruction decode circuit 220, the decoded instructions 206D are provided to a rename/allocate circuit 222 as another pipeline stage in the instruction processing circuit 204. The rename/allocate circuit 222 is configured to determine if any register names in the decoded instructions 206D need to be renamed to break any register dependencies that would prevent parallel or out-of-order processing. The rename/allocate circuit 222 is also configured to call upon a register map table (RMT) 224 to rename a logical source register operand and/or write a destination register operand of the decoded instruction 206D to available physical registers P₀-P_{X} in a physical register file (PRF) 226. The RMT 224 contains a plurality of mapping entries each mapped to (i.e., associated with) a respective logical register R₀-R_{P}. The mapping entries are configured to store information in the form of an address pointer to point to a physical register P₀-P_{X} in the PRF 226. Each physical register P₀-P_{X} in the PRF 226 contains a data entry 228(0)-228(X) configured to store data for the source and/or destination register operand of a decoded instruction 206D.

With continuing reference to FIG. 2, an issue circuit 230 as another pipeline stage in the instruction pipeline I₀-I_{N} of the instruction processing circuit 204 dispatches decoded instructions 206D when ready (i.e., when their source operands are available) to the execution circuit 218 after identifying and arbitrating among decoded instructions 206D that have all their source operations ready. The produced result(s) from execution of the decoded instructions 206D are written back to memory 232 and/or to the PRF 226 based on whether the destination of the executed instruction 206E is to memory or a logical register R₀-R_{P}. If the fetched and/or decoded instructions 206F, 206D present in the instruction pipeline I₀-I_{N} are no longer valid for any reasons, such as due to a resolved misprediction branch instruction, the execution circuit 218 is configured to issue a flush event 234 to the instruction fetch circuit 212 to indicate which new instructions 206 to fetch for processing and execution.

The instructions 206 in the instruction stream 208 may contain loops. A loop is a sequence of instructions 206 in the instruction stream 208 that repeat (i.e., processed) sequentially in a back-to-back arrangement. A loop can be present in the instruction stream 208 as a result of a programmed software construct that is compiled into a loop among the instructions 206. A loop can also be present in the instruction stream 208 even if not part of a higher-level, programmed, software construct, such as based on binary instructions resulting from compiling of a higher-level, programmed, software construct. If the instructions 206 that are part of a loop could be detected when such instructions 206 are processed in an instruction pipeline I₀-I_{N}, these instructions 206 could be captured and replayed into the instruction stream 208 in processing stages in an instruction pipeline I₀-I_{N} without having to re-fetch and/or re-decode such instructions 206, for example, for the subsequent iterations of the loop. Note that a loop can include further internal loops. Thus, a sequence of instructions 206 that is detected and captured as a captured loop can capture one path of a loop and thus appear to be a branch-free loop body that does not have further internal branches. For example, if loop has alternating conditions of branch taken and not taken, two (2) loops can be captured to represent the overall loop.

In this regard, the instruction processing circuit 204 in this example includes the loop buffer circuit 210 to perform loop buffering. As discussed in more detail below, the loop buffer circuit 210 is configured to detect a loop in instructions 206 fetched into an instruction pipeline I₀-I_{N} as an instruction stream 208 to be processed and executed. The loop buffer circuit 210 is configured to detect loops among the instructions 206 in the instruction stream 208. In response to a detected loop, the loop buffer circuit 210 is configured to capture (i.e., loop buffer) the instructions 206 in the detected loop to be replayed to avoid or reduce the need to re-fetch the instructions 206 in the detected loop, since the processing of these instructions 206 is repeated in the instruction pipeline I₀-I_{N}. In this regard, the loop buffer circuit 210 is configured to insert (i.e., replay) the captured loop instructions 206 in an instruction pipeline I₀-I_{N} for iterations of the loop. In this manner, the instructions 206 in the captured loop do not have to be re-fetched and/or re-decoded, for example, for the subsequent iterations of the loop. Thus, loop buffering can conserve power by the instruction fetch circuit 212 not having to re-fetch the instructions 206 in a detected loop for subsequent iterations of the loop. Loop buffering can also conserve power by the instruction decode circuit 220 not having to re-decode the instructions 206 in a detected loop for subsequent iterations of the loop.

As discussed in more detail below, the loop buffer circuit 210 is also configured to determine if loop optimizations are available to be made in run-time based on a captured loop to enhance performance of the replay of the loop, and to perform such loop optimizations if available. Because the captured loop may contain more instructions 206 for a captured loop than would otherwise be present in an instruction pipeline I₀-I_{N} or a particular pipeline stage for processing at a given time, the processor can use this enhanced visibility of a larger number of instructions 206 in a loop captured in the loop buffer circuit 210 to determine loop optimizations for the loop. These loop optimizations may not be possible to determine otherwise at compile time and/or at run-time based only on the knowledge of the presence of certain instructions 206 of the loop within an instruction pipeline I₀-I_{N}. In this regard, if the loop buffer circuit 210 determines that, if loop optimizations are available to be made based on a captured loop, the loop buffer circuit 210 is configured to modify at least one instruction 206 in the captured loop to produce an optimized loop. The optimized loop can then be replayed in an instruction pipeline I₀-I_{N} when the loop is to be re-processed and re-executed in the instruction pipeline I₀-I_{N} in an iteration(s) so that the loop optimization is realized by the processor 200. To effectuate loop optimizations, the loop buffer circuit 210 is configured to cause an optimized loop to be replayed that is injected into the instruction pipeline I₀-I_{N} in one of a number of stages, including the rename/allocate circuit 222 (e.g., instruction replay), the instruction fetch circuit 212 (e.g., for controlling/pausing new instruction 206 fetching during replay), and the issue circuit 230 (for providing scheduling hints to schedule issuance of replayed instructions 206D).

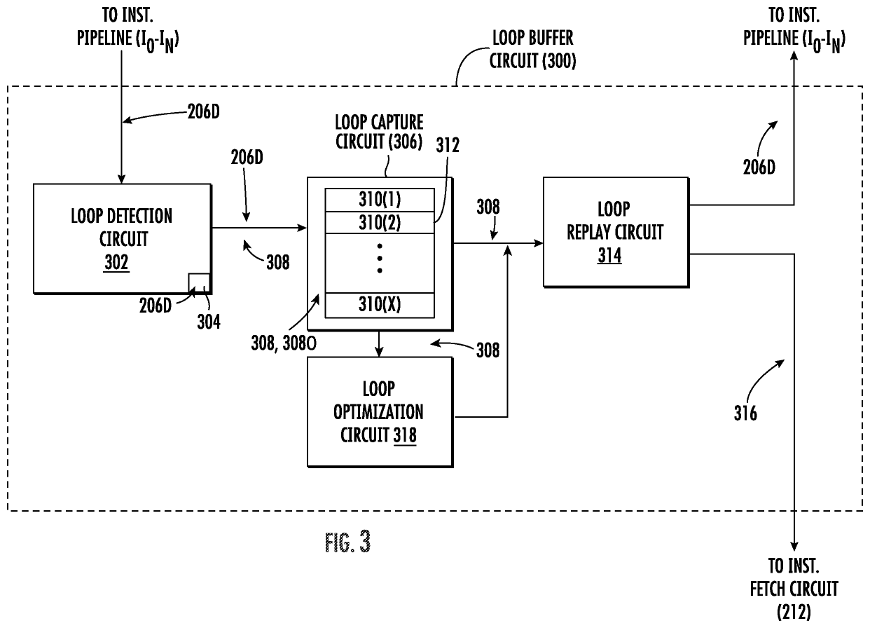

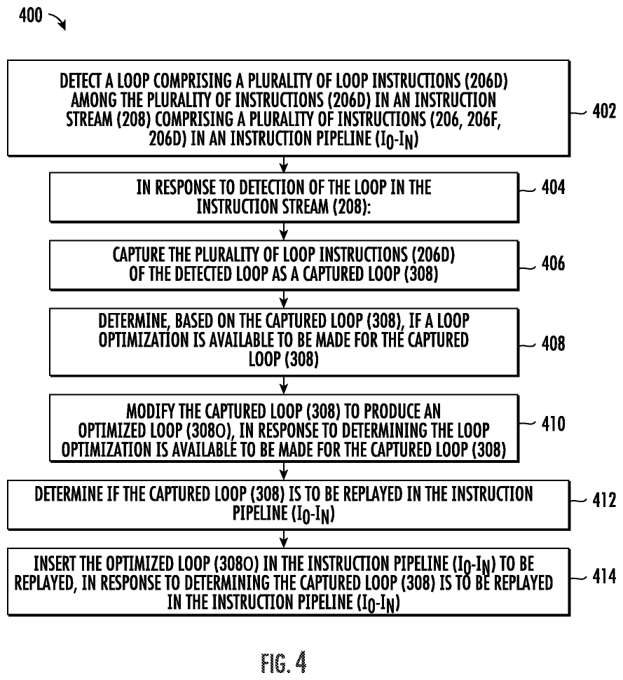

FIG. 3 is a diagram of an exemplary loop buffer circuit 300 that can be provided as the loop buffer circuit 210 in FIG. 2. The exemplary operation of the loop buffer circuit 300 in FIG. 3 is discussed on conjunction with the exemplary process 400 in FIG. 4 of detecting and capturing loop and effectuating loop optimizations for the captured loop to optimize its processing efficiency on replay. The loop buffer circuit 300 is described with reference to the processor 200 in FIG. 2. In this regard, as shown in FIG. 3, the loop buffer circuit 300 in this example includes a loop detection circuit 302. The loop detection circuit 302 is coupled to the instruction pipeline I₀-I_{N} and is configured to receive copies or instances of decoded instructions 206D in this example that are in the instruction stream 208 of the instruction processing circuit 204. The loop detection circuit 302 is configured to detect if a loop is present in the decoded instructions 206D in the instruction stream 208 in an instruction pipeline I₀-I_{N} (block 402 in FIG. 4). If a loop is present, the loop will include a plurality of loop instructions 206D among the decoded instructions 206D. For example, the loop detection circuit 302 may include an instruction buffer circuit 304 that is configured to store decoded instructions 206D as they flow through an instruction pipeline I₀-I_{N} after being decoded by the instruction decode circuit 220 (FIG. 2). The loop detection circuit 302 can reference the stored instructions 206D to determine if follow-on younger instructions 206D repeat the captured instructions 206D. Stored instructions 206D that are detected by the loop detection circuit 302 to repeat sequentially in an instruction pipeline I₀-I_{N} are deemed to be a captured loop.

In response to the loop detection circuit 302 detecting a loop of stored instructions 206D in the instruction stream 208 as a loop (block 404 in FIG. 4), the loop detection circuit 302 is configured to communicate the stored instructions 206D of the loop to a loop capture circuit 306 as a captured loop 308. The loop capture circuit 306 captures the detected loop instructions 206D for the capture loop 308 in ‘X’ number of instruction entries 310(1)-310(X) in a loop buffer memory 312 (block 406 in FIG. 4). In this manner, the loop capture circuit 306 has a record and instance of the instructions 206D of the captured loop 308. Note that the loop buffer memory 312 can be provided as part of the loop capture circuit 306 and/or the loop buffer circuit 300 or as a separate memory circuit in the processor 202 in FIG. 2 as examples.

With continuing reference to FIG. 3, the loop buffer circuit 300 in this example also includes a loop optimization circuit 318. As discussed in a number of examples in more detail below, the loop optimization circuit 318 is configured to determine, based on the captured loop 308 captured by the loop capture circuit 306, if a loop optimization is available to be made for the captured loop 308 (block 408 in FIG. 4). The loop optimization circuit 318 can be configured to analyze instructions 206D incrementally as they are captured by the loop capture circuit 306 or once the loop capture circuit 306 captures the fully captured loop 308. In response to the loop optimization circuit 318 determining that a loop optimization is available to be made for the captured loop 308, the loop optimization circuit 318 is configured to modify the captured loop 308 in the loop buffer memory 312 of the loop capture circuit 306 to produce an optimized loop 3080 (block 410 in FIG. 4). An optimized loop 3080 is a modification of the instructions 206D in a captured loop 308 that are replayed to replay the captured loop 308 and/or a modification of how the captured loop 308 is processed in the instruction processing circuit 204 on replay, to potentially process the captured loop 308 more efficiently when replayed. This can increase the throughput of the replay of the captured loop 308 in the instruction processing circuit 204. A loop replay circuit 314 is configured replay the optimized loop 3080 for the captured loop 308 based on the modification of the captured loop 308 by the loop optimization circuit 318.

For example, as discussed in more detail below, certain loop optimizations may be available to be made by the loop optimization circuit 318 based on the captured loop 308 that reduce the number of instructions 206D required to be replayed in the captured loop 308 to still achieve the same functionality of the captured loop 308 when processed in a replay of the captured loop 308 in the instruction processing circuit 204. Also, as discussed in more detail below, other loop optimizations may be available to be made by the loop optimization circuit 318 based on the captured loop 308 that reduce the number of clock cycles required to process and execute a replay of the captured loop 308 in the instruction processing circuit 204, as compared to the number of clock cycles required to execute the replay of the original captured instructions 206D of the captured loop 308 with the same functionality. Also, as discussed in more detail below, other loop optimizations may be available to be made by the loop optimization circuit 318 based on the captured loop 308 that provide for critical instructions, such as timing critical instructions (e.g., load or instructions that are unlocking instructions to unlock dependence flow paths, to be indicated with scheduling hints to be scheduled for execution at a higher priority when replayed in the instruction processing circuit 204). In this manner, such critical instructions may be executed earlier thus making their produced results ready earlier to be consumed by other consumer instructions in the captured loop 308 that are replayed. This can increase the throughput of replaying captured loops 308 in the instruction processing circuit 204.

Also, as discussed in more detail below, yet other loop optimizations may be available to be made by the loop optimization circuit 318 based on the captured loop 308 that can identify instructions that are load/store operations that can separated from the captured loop 308 as an instruction execution slice. An instruction execution slice in a captured loop is a set of instructions 206D in the captured loop 308 that compute load/store memory addresses needed for memory load/store instructions to be executed in replay of the captured loop 308. The loop optimization circuit 318 can be configured to convert an identified extracted instruction execution slice from a captured loop 308 into a software prefetch instruction(s) that can then be injected into a pre-fetch stage(s) in the instruction pipeline I₀-I_{N} when the captured loop 308 is replayed to perform the loop optimization for the captured loop 308. The processing of the software prefetch instruction(s) for the instruction execution slice will cause the instruction processing circuit 204 to perform the extracted instructions 206D in the instruction execution slice earlier in the instruction pipeline I₀-I_{N} as pre-fetch instructions 206. Thus, any resulting cache misses from the memory operations performed by processing the extracted execution slice instructions as pre-fetch instructions 206 can be recovered earlier for consumption by the dependent instructions in the captured loop 308 when the captured loop 308 is replayed.

With continued reference to FIG. 3, the loop capture circuit 306 is configured to provide the instructions 206D of the captured loop 308 to a loop replay circuit 314 to be replayed (i.e., processed again in another iteration of the loop) in an instruction pipeline I₀-I_{N} of the instruction processing circuit 204. The loop replay circuit 314 determines if the captured loop 308 is to be replayed (block 412 in FIG. 4). In response to determining the captured loop 308 is to be replayed, the loop replay circuit 314 can insert instructions 206D of the captured loop 308 or optimized loop 3080 in an instruction pipeline I₀-I_{N} to be replayed (block 414 in FIG. 4). The loop replay circuit 314 is coupled to the instruction pipelines I₀-I_{N} such that the loop replay circuit 314 can insert instructions 206D of the captured loop 308 in an instruction pipeline I₀-I_{N} to be replayed. In this example, the loop replay circuit 314 is configured to inject or insert the instruction 206D for the captured loop 308 or optimized loop 3080 in the instruction pipeline I₀-I_{N} after the instruction decode circuit 220 in FIG. 2 since there is not a need to re-decode the fetched instructions 208F in the detected loop. In this example, the loop replay circuit 314 is configured to inject or insert the instruction 206D for the captured loop 308 or optimized loop 3080 in the instruction pipeline I₀-I_{N} before the rename/allocate circuit 222 in FIG. 2 since the processor 200 in this example is an out-of-order processor. Thus, the decoded instructions 206D from the captured loop 308 or optimized loop 3080 to be replayed may be processed and/or executed out-of-order according to the issuance of the decoded instructions 206D by the issue circuit 230.

The loop replay circuit 314 is also coupled to the instruction fetch circuit 212 in this example. This is so that when the loop replay circuit 314 replays a loop, the loop replay circuit 314 can send a loop replay indicator 316 to the instruction fetch circuit 212. The instruction fetch circuit 212 can discontinue fetching of instructions 206D for the captured loop 308 while they are being replayed (inserted) into the instruction pipeline I₀-I_{N} of the instruction processing circuit 204.

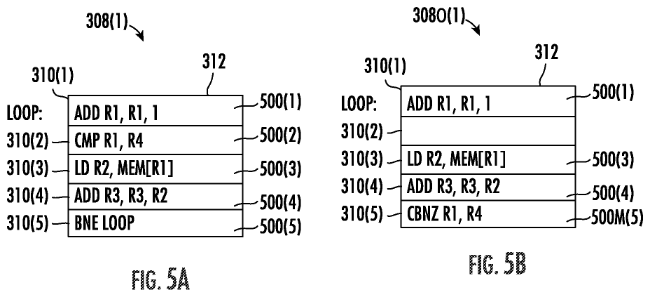

As discussed above, some captured loops 308 may have an available optimization where instructions 206D in the captured loops 308 can be modified by being removed or combined to optimize the captured loop 308 into an optimized loop 3080 for replay. In this regard, FIG. 5A is a diagram of an exemplary captured loop 308(1) of instructions 500(1)-500(5) that are captured in respective instruction entries 310(1)-310(5) in the loop buffer memory 312 in FIG. 3 from decoded instructions 206D from the instruction processing circuit 204 in FIG. 2. The instructions 500(1)-500(5) are contained in respective instruction entries 310(1)-310(5) of the loop buffer memory 312 in this example. As shown in FIG. 5A, the second instruction 500(2) in the captured loop 308(1) is a compare instruction to compare register r1 to register r4 (‘cmp r1, r4’). The compare instruction 502(1) is an instruction that will provide a result to the flags register of the processor 202. Also, as shown in FIG. 5A, the fifth instruction 500(5) in the captured loop 308(1) is a branch if not equal (BNE) instruction to branch back to the first instruction 500(1) in the captured loop 308(1). Thus, the BNE instruction is a consumer instruction of the flags register that is set by the execution of the older compare operation of the second instruction 500(2).

The loop optimization circuit 318 in FIG. 3 can be configured to detect the presence of the flag producer instruction 500(2) in the captured loop 308(1) and the flag consumer instruction 505(5). The loop optimization circuit 318 in FIG. 3 can detect that the instructions 500(2)-504(4) between the producer and consumer flag instructions 500(1), 500(5) do not modify registers r1 or r4. Thus, in this example, the loop optimization circuit 318 can modify the captured loop 308(1) by transforming the instruction 500(5) in the captured loop 308(1) to change it to a compare and branch if not equal (CBNZ) instruction 500M(5) as shown in the optimized loop 3080(1) in FIG. 5B of the captured loop 308(1) in FIG. 5A. Thus, the loop optimization circuit 318 can also transform the second instruction 500(2) by removing the second instruction 500(2) from instruction entry 310(2) in the loop buffer memory 312 for the captured loop 308(1) in FIG. 5A as the optimized loop 3080(1) in FIG. 5B such that the second instruction 500(2) is fused with the modified CBNZ instruction 500M(5) in the optimized loop 3080(1). In this manner, when the captured loop 308(1) in FIG. 5B is replayed as the optimized loop 3080(1) in FIG. 5B, one (1) less instruction has to be replayed among the instructions 500(1), 500(3)-504(4), and 500M(5) than would otherwise be replayed if the captured loop 308(1) in FIG. 5A was replayed. This can result in a faster replay of the captured loop 308(1).

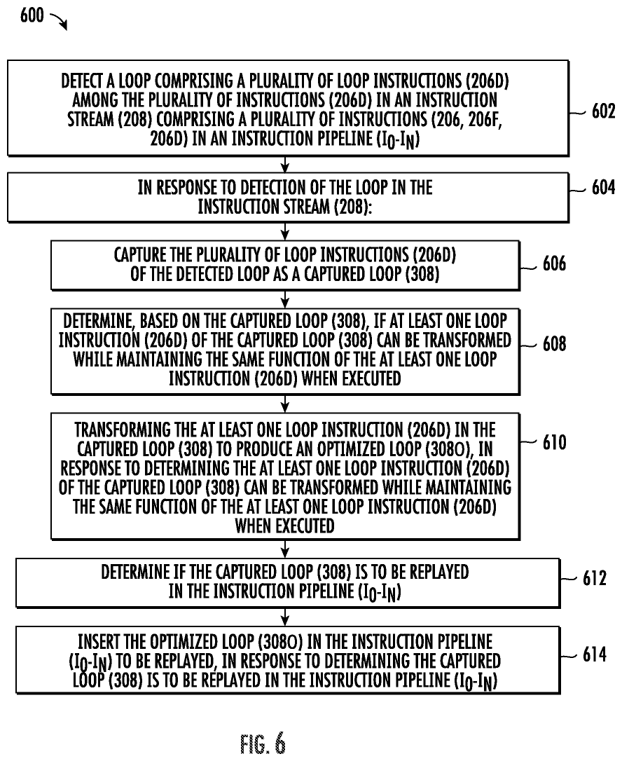

FIG. 6 is a flowchart illustrating an exemplary process 600 of the loop buffer circuit 300 in FIG. 2 capturing detected loops and effectuating a determined loop optimization(s) by transforming an instruction(s) in the captured loop 308 into an optimized loop 3080 to enhance performance of the replay of a captured loop 308. The process 600 in FIG. 6 can be employed by the loop buffer circuit 300 to produce the optimized loop 3080(1) in FIG. 5B based on the captured loop 308(1) in FIG. 5A as an example. The process 600 in FIG. 6 will be discussed in reference to the loop buffer circuit 300 in FIG. 3 and the instruction processing circuit 204 in FIG. 2. Note that when the loop buffer circuit 300 is referenced with regard to the process 600 in FIG. 6, the specific circuits referenced previously in the loop buffer circuit 300 in FIG. 3 can be configured to perform the stated processes even if not explicitly referenced when discussing the process 600 in FIG. 6.

In this regard, the process steps 602, 604, 606 are the same as process steps 402, 404, 406 in the process 400 in FIG. 4 previously described above, and thus will not be repeated. As shown in step 408, the loop buffer circuit 300 is configured to determine, based on the captured loop 308, if at least one loop instruction 206D of the captured loop 308 can be transformed while maintaining the same function of the at least one loop instruction 206D when executed (block 608 in FIG. 6). In response to determining that the at least one loop instruction 206D of the captured loop 308 can be transformed while maintaining the same function of the at least one loop instruction 206D when executed, the loop buffer circuit 300 is also configured to transform the at least one loop instruction 206D in the captured loop 308 to produce the optimized loop 3080 (block 610 in FIG. 6). With continued reference to FIG. 6, the loop buffer circuit 300 is configured to provide the instructions 206D of the captured loop 308 to a loop replay circuit 314 to be replayed (i.e., processed again in another iteration of the loop) in an instruction pipeline I₀-I_{N} of the instruction processing circuit 204. The loop buffer circuit 300 determines if the captured loop 308 is to be replayed (block 612 in FIG. 4). In response to determining the captured loop 308 is replayed, the loop buffer circuit 300 can insert instructions 206D of the captured loop 308 or optimized loop 3080 in an instruction pipeline I₀-I_{N} to be replayed (block 614 in FIG. 4).

Note that the loop buffer circuit 300 can be configured to find producer and consumer pair instructions 206D in a captured loop 308 that can be fused in an optimized loop 3080 to provide a loop optimization. Also note that the loop buffer circuit 300 can also be configured to find producer and consumer pair instructions 206D that occur across different iterations of a captured loop 308 when replayed. For example, the same instruction 206D in captured loop 308 may be both a producer and consumer instruction. Such an instruction 206D be a producer instruction for itself as a consumer instruction in a subsequent iteration of replay of the captured loop 308. Thus, the loop buffer circuit 300 can be configured to identify instructions 206D in a captured loop 308 that can be fused with itself to produce an optimized loop 3080 for replay.

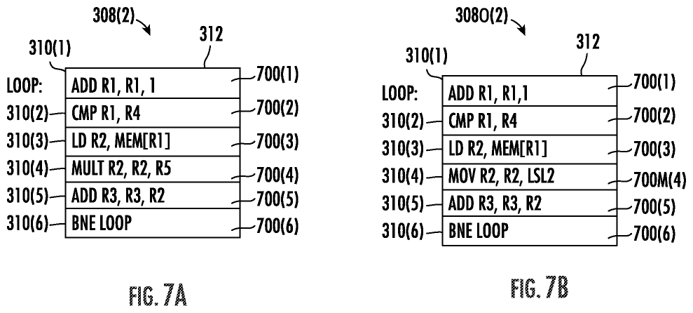

FIG. 7A is a diagram of another exemplary captured loop 308(2) of instructions 700(1)-700(6) that are captured in respective instruction entries 310(1)-310(6) in the loop buffer memory 312 in FIG. 3 from decoded instructions 206D from the instruction processing circuit 204 in FIG. 2, where another transformation optimization to realize an instruction strength reduction can be detected by the loop buffer circuit 300 in run time. As shown in FIG. 7A, the fourth instruction 700(4) in instruction entry 310(4) in the loop buffer memory 312 for the captured loop 308(2) is a multiply instruction of value contained in register r2 with the value contained in register r5 with the result being stored back in register r2 (‘mult r2, r2, r5’). The loop buffer circuit 300, and its loop optimization circuit 318, in FIG. 3 can be configured to detect that there are no other instructions in the captured loop 308(1) that are producers to register ‘r5.’ Thus, the value in register r5 when the captured loop 308(2) is played in its first instance in the instruction processing circuit 204 in FIG. 2 will remain the same value in the subsequent iterations of the captured loop 308(2) when replayed. Thus, in this example, the loop optimization circuit 318 can be configured to determine if value stored in register r5 is value that would allow the multiply instruction 700(4) to be transformed to another instruction that would take less clock cycles (i.e., less strength) to execute on replay. If for example, register r5 contains a value of four (4), which is a power of two (2). This means that the loop optimization circuit 318 can transform and replace the multiply instruction 700(4) in the captured loop 308(2) with a move instruction that performs a left shift of the value in r2 by two (2) bit in an optimized loop 3080(2), as shown in modified instruction 700M(4) in instruction entry 310(4), to perform the multiply operation of the value in register r2 by four (4), which is the value in register r5. Thus, the move instruction 700M(4) in the optimized loop 3080(2) is an alternative instruction that will have the same function as the multiple instruction 700(4) in the captured loop 308(2) in FIG. 7A when executed, but can be executed in less clock cycles. In this manner, the multiple by two (2) operation to register r2 can be performed in less clock cycles when the captured loop 308(2) in FIG. 7A is replayed as the optimized loop 3000(2) in FIG. 7B, resulting in faster replays of the captured loop 308(2).

Note that there are other examples of instructions 206D that can be in a captured loop 308 that can be transformed to reduced strength instructions so that the captured loop 308 can be replayed faster and more efficiently. For example, an instruction 206D in a capture loop 308 determined to be an add by zero function could be replaced with a move instruction in an optimized loop 3080.

As another example, the captured loop 308 may contain an instruction 206D that is loop invariant, meaning that the produced value of execution of such instruction 206D will always be the same for any iteration of the replayed loop. For example, such a loop invariant instruction may be an instruction that stores a constant value to a target register, wherein the target register is not modified by any other producer instruction. In this example, to optimize a captured loop 308 with such a loop invariant instruction 206D, the loop optimization circuit 318 in FIG. 3 can remove the loop invariant instruction 206D from the optimized loop 3080 so that the loop invariant instruction is not replayed when the captured loop 308 is replayed as the optimized loop 3080. Thus, the value in the target register from the first play of the captured loop 308 will remain constant and the same, and unchanged during the replay of the captured loop 308 as the optimized loop 3080. This allows the captured loop 308 to be replayed with one less instruction in this example as the optimized loop 3080 for more efficient replay.

In another exemplary aspect, the loop buffer circuit 300, and its loop optimization circuit 318, in FIG. 3 can be configured to perform a loop post-capture instruction transformation analysis of the instructions 206D in a captured loop 308 to detect critical-timing instructions 206D. The loop buffer circuit 300 can be configured to transform such identified critical instructions 206D with scheduling hints that can be used by a scheduling circuit, such as the issue circuit 230 in FIG. 2, to prioritize their issuance for execution by the execution circuit 218 when replayed. For example, instructions 206D in a captured loop 308 that are identified as performing critical loads are critical instructions whose timing can affect other dependent instructions in the captured loop 308. This critical instructions 206D can be transformed with a scheduling hint so that these instructions 206D are scheduled for execution earlier in the instruction processing circuit 204 over other instructions 206D in the captured loop in replay of the captured loop 308. An example of a critical load instruction 206D in a captured loop 308 is a load instruction in a captured loop 308 whose produced result is consumed by a conditional branch instruction 206D. The produced results of the load instruction 206D are necessary to resolve the prediction of the conditional branch instruction 206D. Thus, in the conditional branch instruction 206D, an earlier replay and execution of the critical load instruction 206D can result in a faster resolution of the mispredicted conditional branch instruction 206D. Another example of a critical instruction 206D in a captured loop 308 that can benefit from scheduling hints are instructions 206D identified as having dependence chains within a captured loop 308 and marking such key unlocking instructions 206D with scheduling priority.

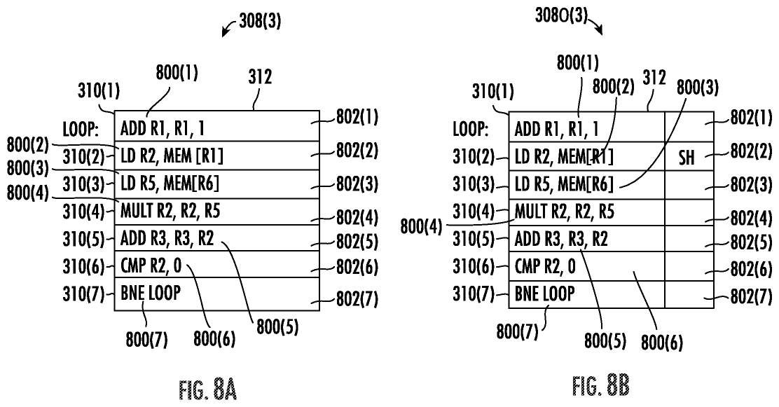

FIG. 8A is a diagram of another exemplary captured loop 308(3) of instructions 800(1)-800(7) that are captured in respective instruction entries 310(1)-310(7) in the loop buffer memory 312 in FIG. 3 from decoded instructions 206D from the instruction processing circuit 204 in FIG. 2, where another transformation optimization to provide a scheduling hint for a critical instruction can be detected by the loop buffer circuit 300 in run time. As shown in FIG. 8A, the second instruction 800(2) in instruction entry 310(2) in the loop buffer memory 312 for the captured loop 308(3) is a load instruction to load the value stored in memory at the memory address in register r1 into register r2. As also shown in FIG. 8A, the sixth instruction 800(6) in instruction entry 310(6) in the loop buffer memory 312 for the captured loop 308(3) is a compare instruction to compare the value stored in register r2 to zero (0). The next instruction 800(7) is a branch if not equal (BNE) instruction that is a conditional branch instruction based on the comparison of register r2 to zero (0) in instruction 800(6). Thus, the conditional branch instruction 800(7) is dependent on the load instruction 800(2). The load instruction 800(2) must be executed to resolve the value in register r2 before it can be determined if the conditional branch instruction 800(7) was mispredicted. Thus, the load instruction 800(2) is a critical timing instruction to the conditional branch instruction 800(7). If conditional branch instruction 800(7) is frequently mispredicted, this means that the misprediction will not be discovered until the load instruction 800(2) is executed.

Thus, in this example, the loop optimization circuit 318 can be configured to determine if the load instruction 800(2) is a producer instruction that is a critical timing instruction to the consumer conditional branch instruction 800(7). The loop optimization circuit 318 can be configured to provide a scheduling hint SH in scheduling priority indicator 802(2) associated with the instruction entry 310(2) that contains the load instruction 800(2) as the optimized loop 3080(3) as shown in FIG. 8B. For example, the instruction entries 310(1)-310(7) in the loop buffer memory 312 can be appended to also include respective scheduling priority indicators 802(1)-802(7) so that the loop optimization circuit 318 can indicate scheduling priority of any such instructions 800(1)-800(7) to provide a determined optimization of the captured loop 308(3) as the optimized loop 3080(3). This scheduling hint can then be accessed by the loop replay circuit 314 in FIG. 3 when the optimized loop 3080(3) is to be replayed and provided to the issue circuit 230 in the instruction processing circuit 204 in FIG. 2 when the optimized loop 3080(3) is replayed. The issue circuit 230 can use the indication of the scheduling hint SH for the load instruction 800(2) to then to know to schedule the load instruction 800(2) for execution by the execution circuit 218 at a higher priority if possible. In this manner, the load instruction 800(2) may be resolved sooner, so that it can be determined sooner if the prediction for the conditional branch instruction 800(7) was incorrect. Recover procedures to recover from a misprediction of the conditional branch instruction 800(7) can then be performed sooner than may otherwise be performed if the load instruction 800(2) were resolved later.

As another example, the captured loop 308 may contain a critical instruction 206D that is critical as an unlocking instruction 206D between parallel dependence chains within a captured loop 308. For example, a captured loop 308 may contain many independent load instructions 206D or longer-latency instructions 206D that are producer instructions to other consumer instructions. These load instructions 206D or longer-latency instructions 206D that are producer instructions to other consumer instructions are known as critical “unlocking” instructions. Thus, these unlocking instructions 206D could be prioritized to be executed earlier in a replay of a captured loop 308 to realize additional performance from other consumer instructions being able to be issued sooner by the issue circuit 230 in FIG. 2 due to their operands being available sooner. In this regard, as discussed above, the loop optimization circuit 318 can be configured to provide a scheduling hint SH in scheduling priority indicator associated with the instruction entry 310(1)-310(X) that contains such a critical unlocking instruction 206D of a captured loop 308 to produce an optimized loop 3080. This scheduling hint can then be accessed by the loop replay circuit 314 in FIG. 3 when the optimized loop 3080 is to be replayed and provided to the issue circuit 230 in the instruction processing circuit 204 in FIG. 2 when the optimized loop 3080 is replayed. The issue circuit 230 can use the indication of the scheduling hint SH for the unlocking instruction 206D to then know to schedule the unlocking instruction 206D for execution by the execution circuit 218 at a higher priority if possible. In this manner, the unlocking instruction 206D may be resolved sooner so that dependent instructions can be scheduled for execution by the issue circuit 230 sooner.

In another exemplary aspect, the loop buffer circuit 300, and its loop optimization circuit 318, in FIG. 3 can be configured to determine a loop optimization(s) for a captured loop 308 by performing a loop post-capture instruction analysis of the instructions 206D in the captured loop 308 to identify any instruction execution slices. An instruction execution slice in a captured loop 308 is a set of instructions 206D in the captured loop 308 that compute load/store memory addresses needed for memory load/store instructions to be executed in replay of the captured loop 308. Memory loads and stores within a replayed captured loop 308 that result in a cache miss result in a performance penalty in instruction pipeline throughput when the captured loop 308 is replayed. However, memory loads and stores within a replayed captured loop 308 that more frequently result in cache misses may result in an enhanced performance penalty in an instruction pipeline throughput as a function of the number of its replay iterations of the captured loop 308.

Thus, as discussed in more detail below, the loop buffer circuit 300 can be configured to extract an identified instruction execution slice identified in the instructions 206D of a captured loop 308. The loop buffer circuit 300 can be configured to convert an identified extracted instruction execution slice into a software prefetch instruction(s) that can then be injected into a pre-fetch stage(s) in the instruction pipeline, such as an instruction pipeline I₀-I_{N} in the processor 200 in FIG. 2, when the captured loop 308 is replayed to perform the loop optimization for the captured loop 308. The processing of the software prefetch instruction(s) for the instruction execution slice will cause the instruction processing circuit 204 of the processor 200 in FIG. 2 to perform the extracted instructions 206D in the instruction execution slice earlier in the instruction pipeline I₀-I_{N} as pre-fetch instructions 206. Thus, any resulting cache misses from the memory operations performed by processing the extracted execution slice instructions as pre-fetch instructions 206 can be recovered earlier for consumption by the dependent instructions 206D when the captured loop 308 is replayed. The extracted instruction execution slice can be stored in a separate buffer apart from the loop buffer memory 312 in FIG. 3 as an example, or within the loop buffer memory 312 with a special identifier (e.g., with extra pointer bits) to be used to generate the software prefetch instruction(s) 206 as examples.

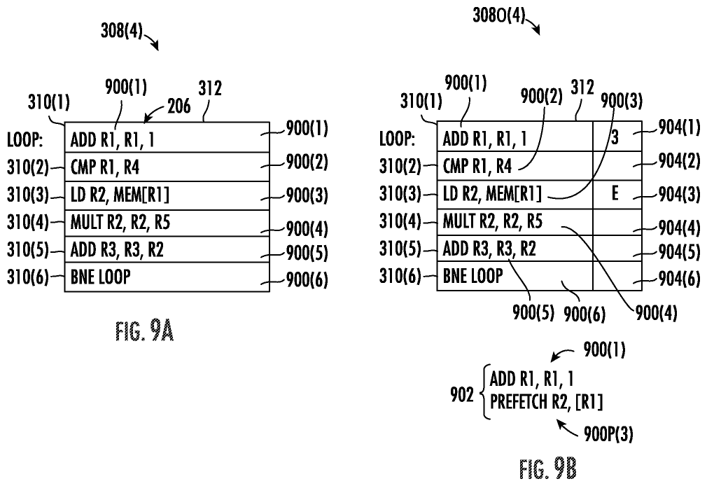

In this regard, FIG. 9A is a diagram of an exemplary captured loop 308(4) of instructions 900(1)-900(6) stored in respective instruction entries 310(1)-310(6) in the loop buffer memory 312 in FIG. 3. The captured loop 308(4) includes an instruction execution slice comprising of instructions 900(1) and 900(3). Instruction 900(1) is an add instruction that adds one (1) to the value stored in register r1 and then stores the result back in register r1. Instruction 900(3) is a load instruction that loads the contents at the memory location in register r1 into register r2. Instructions 900(1) and 900(3) must both be executed to resolve the memory address at register r1 to load its value into register r2. Instructions 900(4) and 900(5) are dependent on register r2 as a source register, and thus instructions 900(4), 900(5) are dependent on the produced results from the load instruction 900(3). Thus, the instruction execution slice that can be identified from the captured loop 308(4) in FIG. 9A are add instruction 900(1) and load instruction 900(3). If the load instruction 900(3) in the captured loop 308(4) results in a cache miss, this delays the execution of instructions 900(4) and 900(5) on replay.

Thus, the loop optimization circuit 318 in FIG. 3 can be configured to detect the instruction execution slice of instructions 900(1), 900(3) and remove these instructions from the captured loop 308(2) on replay as part of an optimized loop 3080(4) as shown in FIG. 9B. The loop optimization circuit 318 in FIG. 3 can be configured to create software pre-fetch instructions 206 in a prefetching mode representing instructions 900(1), 900(3) as a “prefetch slice” or instruction execution slice 902 that are then provided to a pre-fetch stage (e.g., the instruction fetch circuit 212 in the instruction processing circuit 204 in FIG. 2) before the captured loop 308(4) is replayed. As shown in FIG. 9B, the instruction execution slice 902 in this example is based on instructions 900(1) and 900(3) that must both be executed to resolve the memory address at register r1 to load its value into register r2 for dependent instructions 900(4) and 900(5) to be executed. As shown in FIG. 9B, the instruction execution slice is the original add instruction 900(1) followed by a modified instruction 900P(3) of instruction 900(3) that is a ‘prefetch’ instruction to prefetch the contents at memory location at the memory address stored in register r1 (as updated by instruction 900(1)) into register r2. Both instruction 900(1) and instruction 900P(3) are provided as pre-fetch instructions to an instruction pipeline in replay of the optimized loop 3080(4).

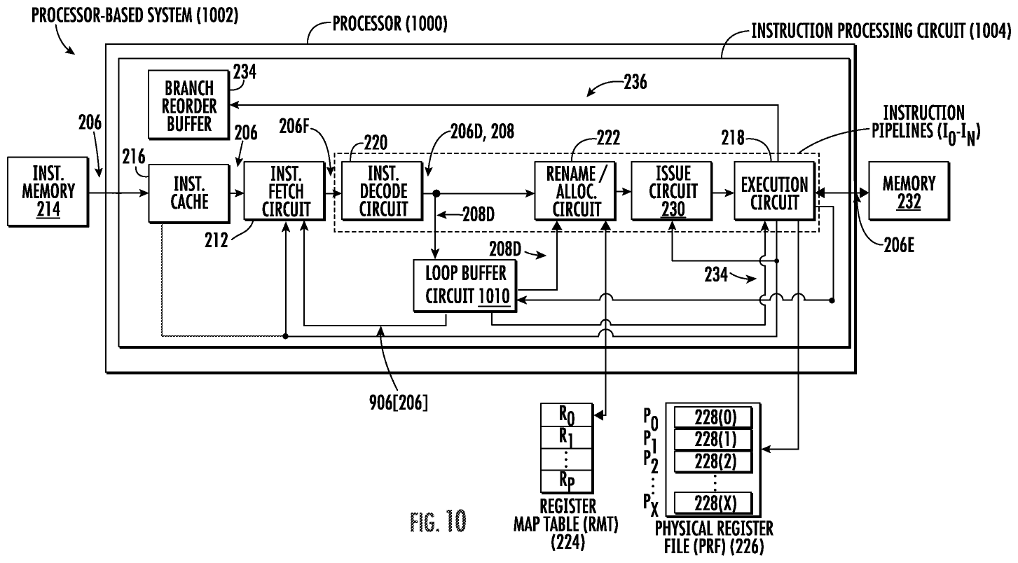

This is shown in the example processor 1000 in the processor-based system 1002 in FIG. 10 that includes the instruction processing circuit 1004. Common components between the processor 1000 in FIG. 10 and the processor 200 in FIG. 2 are shown with common element numbers and thus not re-described. As shown in FIG. 10, a loop buffer circuit 1010 is provided that can be like the loop buffer circuit 210 in FIG. 2 and/or the loop buffer circuit 300 in FIG. 3. The loop buffer circuit 1010 can perform any of the functions discussed above. The loop buffer circuit 1010 can also be configured to provide the software pre-fetch instructions 206 of the instruction execution slice 906 to the instruction fetch circuit 212 to be replayed earlier as prefetch instructions, before the other instructions of the captured loop 308(4) in the example of FIG. 10B are replayed. In this manner, the instruction processing circuit 1004 in FIG. 10 can process the instructions 900(1), 900P(3) as the instruction execution slice 902 of the captured loop 308(4) earlier, before the instruction 900(4), 900(5) from the captured loop 308(4) are replayed, so that the produced results from processing of the instructions 900(1), 900(3) may be available sooner, in the event of a cache miss by the load instruction 900(3). In this regard, the instructions 900(1), 900(3) converted into software prefetch instructions 206 in the instruction execution slice 902 as discussed above and the remaining instructions 900(2) and 900(4)-900(6) constitute an optimized loop for the captured loop 308 in FIG. 9. The instruction execution slice 902 can be replayed to prefetch data stored at memory address of the register r1 into register r2 to load the data into the register r2 for each iteration of the replayed optimized loop 3080(4). Thus, multiple instances of the instruction execution slice 902 are replayed as prefetch instructions for future multiple original loop iterations of the optimized loop 3080(4).

Note that in one example, the instructions 900(1), 900(3) of the prefetch slice 902 can be removed by the loop optimization circuit 318 from the loop buffer memory 312 altogether such that the remaining instructions 206 to be replayed as normal instructions in the optimized loop 3080(4) are instructions 900(2) and 900(4)-900(6). Alternatively, the loop optimization circuit 318 can leave the instructions 900(1), 900(3) of the instruction execution slice 902 remaining the loop buffer memory 312 as shown in FIG. 9B, but provides a pointer in a pointer field 904(1)-904(6) provided as part of the respective instruction entries 310(1)-310(6) in the loop buffer memory 312. The loop optimization circuit 318 can store a pointer value in a respective pointer field 904(1)-904(6) to indicate if its respective instruction 900(1)-900(6) is part of a detected instruction execution slice 902, and such that the pointer value stored in the pointer field 904(1)-904(6) points to the next instruction 900(1)-900(6) in the instruction execution slice 902.

For example, as shown in FIG. 9B, the instruction 900(1) includes the pointer value ‘3’ in its respective pointer field 904(1) signifying instruction 900(1) is part of a detected instruction execution slice 902. The instruction 900(3) includes the pointer value ‘E’ in its respective pointer field 904(3) signifying it is the last instruction 900(3) as part of a detected instruction execution slice 902. In this manner, the loop replay circuit 314 can use these indicators to convert instructions 900(1), 900(3) into software prefetch instructions 206 to be provided to a pre-fetch stage of the instruction processing circuit 1004 to be processed before the remaining instructions 900(2), 900(4)-900(6) are replayed. A benefit of storing the instruction of the instruction execution slice 902 in the loop buffer memory 312 itself is the efficiency of only needing minimal additional bits of memory to signify instructions as part of the instruction execution slice 902, as opposed to having to provide a side storage structure. This can also minimize coupling and entry points needed into the instruction pipeline I₀-I_{N} of the instruction processing circuit 1004 in FIG. 10. The instruction execution slice 902 can be replayed iteratively by using the pointers in the pointer fields 904(1)-904(6).

Note that the software prefetch instructions 206 of the instruction execution slice 902 can be noted as non-architectural instructions, meaning that the instruction processing circuit 1004 will not allocate resources for the processing of such instructions, such as positions in a reorder buffer, committed mapping table, etc. Thus, work performed in the instruction pipeline I₀-I_{N} of the instruction processing circuit 1004 in FIG. 10 as a result of processing the instruction execution slice 902 as prefetch instructions does not update the architectural state of the processor 1000 in this example. Thus, the processing of the instruction execution slice 902 does not affect data from a programmer's perspective. Loaded data resulting from processing instruction execution slice 902 is however brought into data cache of the processor 1000. Resources allocated to the instruction execution slice 902 are freed up in the instruction processing circuit 1004 as soon as their produced values are consumed by the replay of the optimized loop 3080(4). This is because if any prefetch instructions 206 of the instruction execution slice 902 cause a fault, the prefetch instructions 206 of the instruction execution slice 902 can simply be abandoned and not have to be recovered. The prefetch instructions 206 of the instruction execution slice 902 can be replayed from the optimized loop 3080(4) by the loop buffer circuit 1010 in a regular replay mode without having to be generated as pre-fetch instructions.

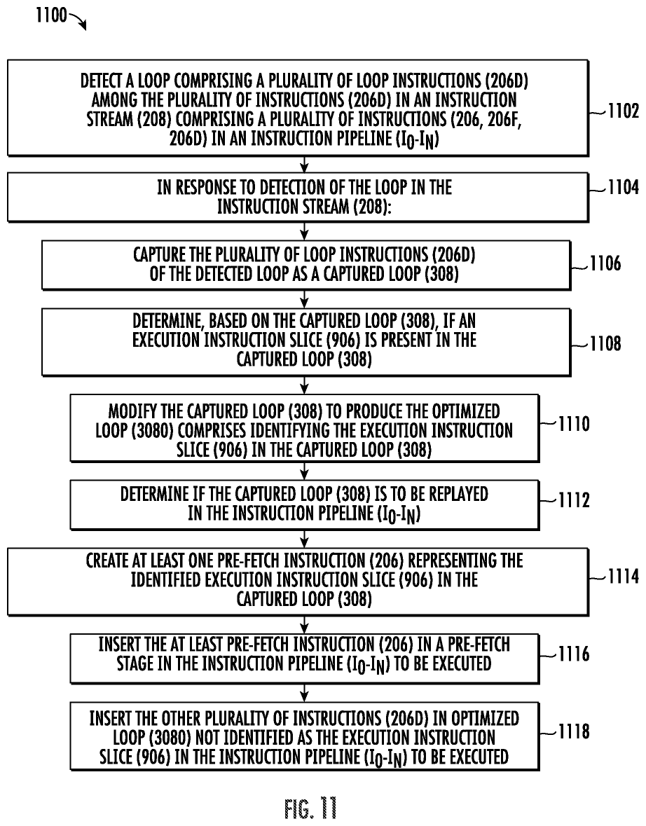

FIG. 11 is a flowchart illustrating an exemplary process 1100 of the loop buffer circuit 1010 in FIG. 10, capturing detected loops, detecting an instruction execution slice 906 in the captured loop 308 as an available loop optimization. The loop buffer circuit 1010 generates and injects software pre-fetch instructions 206 representing the instructions in the detected instruction execution slice 906 in a pre-fetch stage of an instruction pipeline I₀-I_{N} as part of an optimized loop 3080 to realize such loop optimization when the captured loop 308 is replayed. The process 1100 in FIG. 11 will be discussed in reference to the loop buffer circuit 1010 and the instruction processing circuit 1004 in FIG. 2. Note that when the loop buffer circuit 1010 is referenced with regard to the process 1100 in FIG. 11, the specific circuits referenced previously in the loop buffer circuit 300 in FIG. 3 can be configured to perform the stated processes even if not explicitly referenced when discussing the process 1100 in FIG. 11.

In this regard, the process steps 1102, 1104, 1106 are the same as process steps 402, 404, 406 in the process 400 in FIG. 4 previously described above, and thus will not be repeated. A next step in the process 1108 in FIG. 11 is the loop buffer circuit 1010 determining, based on the captured loop 308, if an instruction execution slice 906 is present in the captured loop 308 (block 1108 in FIG. 11). If an instruction execution slice 906 is present in the captured loop 308 (block 1108 in FIG. 11), the loop buffer circuit 1010 modifies the captured loop 308 to produce the optimized loop 3080 comprising identifying the instruction execution slice 906 in the captured loop 308 (block 1110 in FIG. 11). The loop buffer circuit 1010 determines if the captured loop 308 is to be replayed in the instruction pipeline I₀-I_{N} (block 1112 in FIG. 11). If the loop buffer circuit 1010 determines if the captured loop 308 is to be replayed in the instruction pipeline I₀-I_{N} (block 1112 in FIG. 11), the loop buffer circuit 1010 creates at least one pre-fetch instruction 206 representing the identified instruction execution slice 906 in the captured loop 308 (block 1114 in FIG. 11), and inserts the at least one pre-fetch instruction 206 in a pre-fetch stage in the instruction pipeline I₀-I_{N} to be executed (block 1116 in FIG. 11). The loop buffer circuit 1010 then inserts the other plurality of instructions 206D in optimized loop 3080 not identified as the instruction execution slice 906 in the instruction pipeline I₀-I_{N} to be executed (block 1118 in FIG. 11).

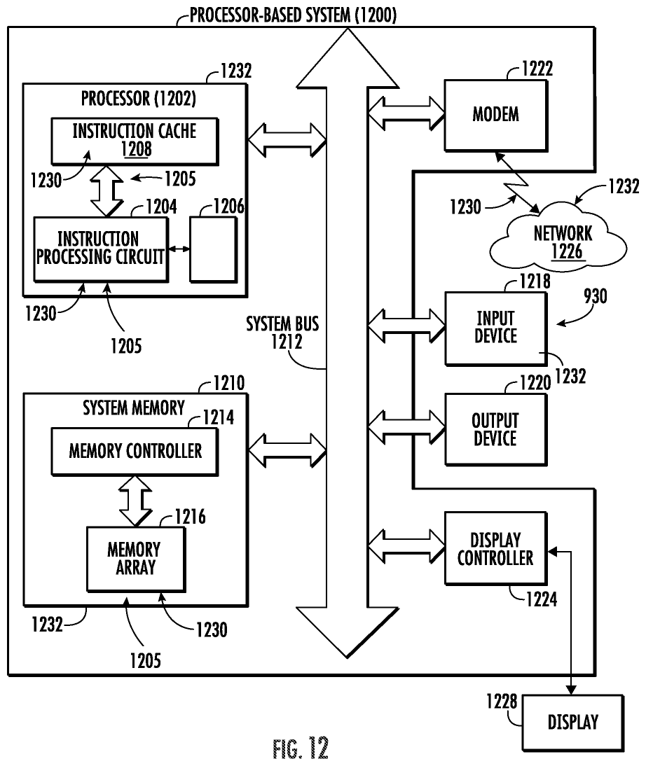

FIG. 12 is a block diagram of an exemplary processor-based system 1200 that includes a processor 1202 (e.g., a microprocessor) that includes an instruction processing circuit 1204 for processing and executing instructions 1205. The processor 1202 and/or the instruction processing circuit 1204 can include a loop buffer circuit 1206 that can be configured to detect and capture loops from processed instructions 1205 in the instruction processing circuit 1204. The loop buffer circuit 1206 can also be configured to determine if loop optimizations are available to be made based on a captured loop to enhance performance of loop replay. If the loop buffer circuit 1206 determines loop optimizations are available to be made based on a captured loop, the loop buffer circuit 1206 is configured to perform such loop optimizations so that such loop optimizations can be realized when the captured loop is replayed to enhance replay performance of the captured loop. For example, the processor 1202 in FIG. 12 could be the processor 200 in FIG. 2 that includes the instruction processing circuit 204 and the loop buffer circuit 210 or the processor 1202 in FIG. 12 that includes the instruction processing circuit 1204 and the loop buffer circuit 1206. The loop buffer circuit 1206 in FIG. 12 can be the loop buffer circuit 210 in FIG. 2, the loop buffer circuit 300 in FIG. 3, or the loop buffer circuit 1010 in FIG. 10 as examples.

The processor-based system 1200 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer. In this example, the processor-based system 1200 includes the processor 1202. The processor 1202 represents one or more processing circuits, such as a microprocessor, central processing unit, or the like. The processor 1202 is configured to execute processing logic in instructions for performing the operations and steps discussed herein. Fetched or prefetched instructions from a memory, such as from a system memory 1210 over a system bus 1212, are stored in an instruction cache 1208. The instruction processing circuit 1204 is configured to process instructions 1205 fetched into the instruction cache 1208 and process the instructions for execution. These instructions 1205 fetched from the instruction cache 1208 to be processed can include loops that are detected by the loop buffer circuit 1206 for replay based on prediction of one or more loop characteristics as loop characteristic predictions.

The processor 1202 and the system memory 1210 are coupled to the system bus 1212 and can intercouple peripheral devices included in the processor-based system 1200. As is well known, the processor 1202 communicates with these other devices by exchanging address, control, and data information over the system bus 1212. For example, the processor 1202 can communicate bus transaction requests to a memory controller 1214 in the system memory 1210 as an example of a slave device. The instructions 1205 can also be stored in the system memory 1210 and retrieved from system memory 1210 for execution by the instruction processing circuit 1204. Although not illustrated in FIG. 12, multiple system buses 1212 could be provided, wherein each system bus constitutes a different fabric. In this example, the memory controller 1214 is configured to provide memory access requests to a memory array 1216 in the system memory 1210. The memory array 1216 is comprised of an array of storage bit cells for storing data. The system memory 1210 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 1212. As illustrated in FIG. 12, these devices can include the system memory 1210, one or more input device(s) 1218, one or more output device(s) 1220, a modem 1222, and one or more display controllers 1224, as examples. The input device(s) 1218 can include any type of input device, including, but not limited to, input keys, switches, voice processors, etc. The output device(s) 1220 can include any type of output device, including, but not limited to, audio, video, other visual indicators, etc. The modem 1222 can be any device configured to allow exchange of data to and from a network 1226. The network 1226 can be any type of network, including, but not limited to, a wired or wireless network, a private or public network, a local area network (LAN), a wireless local area network (WLAN), a wide area network (WAN), a BLUETOOTH™ network, and the Internet. The modem 1222 can be configured to support any type of communications protocol desired. The processor 1202 may also be configured to access the display controller(s) 1224 over the system bus 1212 to control information sent to one or more displays 1228. The display(s) 1228 can include any type of display, including, but not limited to, a cathode ray tube (CRT), a liquid crystal display (LCD), a plasma display, etc.

The processor-based system 1200 in FIG. 12 may include a set of instructions 1230 to be executed by the instruction processing circuit 1204 of the processor 1202 for any application desired according to the instructions 1230. The instructions 1230 may include loops as processed by the instruction processing circuit 1204. The instructions 1230 may be stored in the system memory 1210, processor 1202, and/or instruction cache 1208 as examples of a non-transitory computer-readable medium 1232. The instructions 1230 may also reside, completely or at least partially, within the system memory 1210 and/or within the processor 1202 during their execution. The instructions 1230 may further be transmitted or received over the network 1226 via the modem 1222, such that the network 1226 includes the non-transitory computer-readable medium 1232. The instructions 1230 may also be executed by the processor 1202 to perform the functions of the loop buffer circuit 1206 to detect and capture loops, and perform optimizations of loops for replay.

While the non-transitory computer-readable medium 1232 is shown in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor comprising,
an instruction processing circuit configured to process an instruction stream comprising a plurality of instructions in an instruction pipeline; and
a loop buffer circuit configured to:
detect a loop comprising a plurality of loop instructions among the plurality of instructions in the instruction stream;
in response to detection of the loop in the instruction stream:
capture the plurality of loop instructions of the detected loop as a captured loop;
determine, based on the captured loop, if a loop optimization is available to be made for the captured loop; and
in response to determining the loop optimization is available to be made for the captured loop, modify the captured loop to produce an optimized loop;
determine if the captured loop is to be replayed in the instruction pipeline; and
in response to determining the captured loop is to be replayed in the instruction pipeline, insert the optimized loop in the instruction pipeline to be replayed.

2. The processor of claim 1, wherein the loop buffer circuit comprises:
a loop detection circuit configured to detect the loop comprising the plurality of loop instructions among the plurality of instructions in the instruction stream in the instruction pipeline to be executed;
a loop capture circuit configured to capture the plurality of loop instructions of the detected loop as the captured loop;
a loop optimization circuit configured to:
determine if the loop optimization is available to be made for the captured loop, based on the captured loop; and
in response to determining the loop optimization is available to be made for the captured loop, modify the captured loop to produce the optimized loop; and
a loop replay circuit configured to, in response to determining the captured loop is to be replayed in the instruction pipeline, insert the optimized loop in the instruction pipeline to be replayed.

3. The processor of claim 1, further comprising a loop buffer memory comprising a plurality of instruction entries each configured to store an instruction among the plurality of instructions;
wherein the loop buffer circuit is configured to:
capture the plurality of loop instructions of the detected loop as the captured loop by being configured to:
store each loop instruction among the plurality of loop instructions in an instruction entry among the plurality of instructions entries in the loop buffer memory;
determine if the loop optimization is available to be made based on the captured loop by being configured to:
access the plurality of loop instructions for the captured loop in the plurality of instruction entries in the loop buffer memory; and
determine, based on the accessed plurality of loop instructions for the captured loop in the plurality of instruction entries in the loop buffer memory, if the loop optimization is available to be made for the captured loop;
in response to determining the loop optimization is available to be made for the captured loop, modify at least one instruction entry among the plurality of instruction entries in the loop buffer memory for the captured loop to produce the optimized loop; and
in response to determining the captured loop is to be replayed in the instruction pipeline, insert the optimized loop from the loop buffer memory in the instruction pipeline to be replayed.

4. The processor of claim 1, wherein the loop buffer circuit is configured to:
determine if the loop optimization is available to be made for the captured loop, based on the captured loop by being configured to:
determine if at least one loop instruction among the plurality of loop instructions in the captured loop can be transformed while maintaining the same function of the at least one loop instruction when executed; and
in response to determining the at least one loop instruction among the plurality of loop instructions in the captured loop can be transformed while maintaining the same function of the at least one loop instruction when executed, transform the at least one loop instruction among the plurality of loop instructions in the captured loop to produce the optimized loop.

5. The processor of claim 3, wherein the loop optimization circuit is configured to:
determine if the loop optimization is available to be made for the captured loop by being configured to determine if at least one loop instruction among the plurality of loop instructions in the captured loop can be transformed while maintaining the same function of the at least one loop instruction when executed; and
in response to determining at least one loop instruction among the plurality of loop instructions in the captured loop can be transformed while maintaining the same function of the at least one loop instruction when executed, modify the at least one instruction entry among the plurality of instruction entries in the loop buffer memory to produce the optimized loop.

6. The processor of claim 4, wherein the loop buffer circuit is configured to:
determine if the at least one loop instruction among the plurality of loop instructions in the captured loop can be transformed by being configured to determine if at least two loop instructions among the plurality of loop instructions in the captured loop can be fused into at least one fused instruction that has the same function of the at least two loop instructions when executed; and
in response to determining the at least two loop instructions among the plurality of loop instructions can be fused into the at least one fused instruction that has the same function of the at least two loop instructions when executed, fuse the at least two loop instructions among the plurality of loop instructions in the captured loop to produce the optimized loop.

7. The processor of claim 4, wherein the loop buffer circuit is configured to:
determine if the at least one loop instruction among the plurality of loop instructions in the captured loop can be transformed by being configured to determine if at least one loop instruction among the plurality of loop instructions in the captured loop can be fused with itself in the captured loop when the captured loop is executed in at least one subsequent iteration of the captured loop; and
in response to determining the at least one loop instruction among the plurality of loop instructions in the captured loop can be fused with itself in the captured loop when the captured loop is executed in at least one subsequent iteration of the captured loop, identify the at least one loop instruction among the plurality of loop instructions in the captured loop to not be replayed on at least one subsequent iteration of the execution of captured loop to produce the optimized loop.

8. The processor of claim 4, wherein the loop buffer circuit is configured to:
determine if the at least one loop instruction among the plurality of loop instructions in the captured loop can be transformed by being configured to determine if the at least one loop instruction among the plurality of loop instructions in the captured loop is loop invariant to the captured loop; and
in response to determining the at least one loop instruction among the plurality of loop instructions in the captured loop is loop invariant to the captured loop, remove the at least one loop instruction among the plurality of loop instructions determined to be loop invariant from the captured loop to produce the optimized loop.

9. The processor of claim 4, wherein the loop buffer circuit is configured to:
determine if the at least one loop instruction among the plurality of loop instructions in the captured loop can be transformed by being configured to determine if the at least one loop instruction among the plurality of loop instructions in the captured loop can be modified to at least one alternative instruction with the same function as the at least one loop instruction and executed in less clock cycles than the at least one loop instruction; and
in response to determining the at least one loop instruction among the plurality of loop instructions in the captured loop can be modified to at least one alternative instruction with the same function as the at least one loop instruction and can be executed in less clock cycles than the at least one loop instruction, transform the at least one loop instruction among the plurality of loop instructions in the captured loop to the at least one alternative instruction to produce the optimized loop.

10. The processor of claim 4, wherein the loop buffer circuit is configured to:
determine if the at least one loop instruction among the plurality of loop instructions in the captured loop can be transformed by being configured to determine if the at least one loop instruction among the plurality the loop instructions in the captured loop is a critical instruction; and
in response to determining the at least one loop instruction among the plurality of loop instructions in the captured loop is a critical instruction, set a scheduling priority indicator associated with the critical instruction to cause the critical instruction to be scheduled for execution at a higher priority in the instruction pipeline when the optimized loop is inserted in the instruction pipeline to be replayed as the optimized loop.

11. The processor of claim 4, further comprising a loop buffer memory comprising a plurality of instructions entries each configured to store an instruction among the plurality of instruction, each instructions entry among the plurality of instructions entries comprising a scheduling priority indicator;
wherein the loop buffer circuit is configured to:
capture the plurality of loop instructions of the detected loop as the captured loop by being configured to:
store each loop instruction among the plurality of loop instructions in an instruction entry among the plurality of instructions entries in the loop buffer memory;
determine if the at least one loop instruction among the plurality the loop instructions in the captured loop is a critical instruction by being configured to:
access the plurality of loop instructions for the captured loop in the plurality of instruction entries in the loop buffer memory; and
determine, based on the accessed plurality of loop instructions for the captured loop in the plurality of instruction entries in the loop buffer memory, if the instruction among the plurality of loop instructions for the captured loop is the critical instruction; and
in response to determining the instruction among the plurality of loop instructions for the captured loop is the critical instruction, set the scheduling priority indicator in the instruction entry associated with the critical instruction among the plurality of instruction entries in the loop buffer memory to cause the critical instruction to be scheduled for execution at a higher priority in the instruction pipeline when the optimized loop is inserted in the instruction pipeline to be replayed as the optimized loop.

12. The processor of claim 10, wherein the loop buffer circuit is configured to determine if the at least one loop instruction among the plurality the loop instructions in the captured loop is a critical instruction, by being configured to determine if the at least one loop instruction among the plurality the loop instructions in the captured loop is a critical load instruction.

13. The processor of claim 10, wherein the loop buffer circuit is configured to determine if the at least one loop instruction among the plurality the loop instructions in the captured loop is a critical instruction, by being configured to determine if the at least one loop instruction among the plurality the loop instructions in the captured loop is an unlocking instruction.

14. The processor of claim 1, wherein the loop buffer circuit is configured to:
determine if the loop optimization is available to be made for the captured loop, based on the captured loop by being configured to:
determine if an instruction execution slice is present among the plurality of loop instructions in the captured loop; and
in response to determining the instruction execution slice is present among the plurality of loop instructions in the captured loop, create the optimized loop by being configured to:
identify the instruction execution slice among the plurality of loop instructions in the captured loop; and
in response to determining the captured loop is to be replayed in the instruction pipeline, insert the optimized loop in the instruction pipeline to be replayed by being configured to:
create at least one pre-fetch instruction representing the identified instruction execution slice in the captured loop;
insert the at least one pre-fetch instruction in a pre-fetch stage in the instruction pipeline to be executed; and
insert the other plurality of instructions in optimized loop not identified as the instruction execution slice in the instruction pipeline to be executed.

15. The processor of claim 14, further comprising a loop buffer memory comprising a plurality of instructions entries each configured to store an instruction among the plurality of instructions;
wherein the loop buffer circuit is configured to:
capture the plurality of loop instructions of the detected loop as the captured loop by being configured to:
store each loop instruction among the plurality of loop instructions in an instruction entry among the plurality of instructions entries in the loop buffer memory;
determine if the instruction execution slice is present among the plurality of loop instructions in the captured loop by being configured to:
access the plurality of loop instructions for the captured loop in the plurality of instruction entries in the loop buffer memory; and
determine, based on the accessed plurality of loop instructions for the captured loop in the plurality of instruction entries in the loop buffer memory, if the instruction execution slice is present among the plurality of loop instructions in the captured loop in the loop buffer memory.

16. The processor of claim 15, wherein:
each instruction entry among the plurality of instruction entries in the loop buffer entry comprises a pointer field configured to store a pointer; and
the loop buffer circuit is configured to:
in response to determining the instruction execution slice is present among the plurality of loop instructions in the captured loop in the loop buffer memory, create the optimized loop by being configured to:
identify the instruction execution slice among the plurality of loop instructions in the captured loop to create the optimized loop, by being configured to set a pointer in a pointer field in at least one instruction entry among the plurality of instruction entries in the loop buffer memory associated with the instruction execution slice; and
in response to determining the captured loop is to be replayed in the instruction pipeline, insert the optimized loop in the instruction pipeline to be replayed by being configured to:
create at least one pre-fetch instruction representing the instruction execution slice in the captured loop based on accessing a pointer in a pointer field for at least one instruction of the instruction execution slice in the at least one instruction entry among the plurality of instruction entries in the loop buffer memory;
insert the at least one pre-fetch instruction in a pre-fetch stage in the instruction pipeline to be executed; and
insert the other plurality of instructions in the optimized loop not identified as the instruction execution slice in the instruction pipeline to be executed.

17. The processor of claim 14, wherein the loop buffer circuit is further configured to:
determine if the captured loop is to be replayed in the instruction pipeline in a regular replay mode; and
in response to determining the captured loop is to be replayed in the instruction pipeline in a regular replay mode:
insert the optimized loop in the instruction pipeline to be replayed.

18. The processor of claim 14, wherein the instruction processing circuit is further configured to execute the inserted at least one pre-fetch instruction in the instruction pipeline as at least one non-architectural instruction.

19. The processor of claim 1, wherein the instruction processing circuit further comprises:
an instruction fetch circuit configured to fetch the plurality of instructions into the instruction pipeline as the instruction stream to be executed; and
an execution circuit configured to execute the plurality of instructions in the instruction stream.

20. A method of replaying an optimized loop based on a captured loop in an instruction pipeline in a processor, comprising:
detecting a loop comprising a plurality of loop instructions among the plurality of instructions in an instruction stream comprising a plurality of instructions in an instruction pipeline;
in response to detection of the loop in the instruction stream:
capturing the plurality of loop instructions of the detected loop as a captured loop;
determining, based on the captured loop, if a loop optimization is available to be made for the captured loop; and
modifying the captured loop to produce an optimized loop, in response to determining the loop optimization is available to be made for the captured loop;
determining if the captured loop is to be replayed in the instruction pipeline; and
inserting the optimized loop in the instruction pipeline to be replayed, in response to determining the captured loop is to be replayed in the instruction pipeline.

21. The method of claim 20, wherein
capturing the plurality of loop instructions of the detected loop as the captured loop comprises store each loop instruction among the plurality of loop instructions in an instruction entry among a plurality of instructions entries in a loop buffer memory;
determining if the loop optimization is available to be made based on the captured loop comprising:
accessing the plurality of loop instructions for the captured loop in the plurality of instruction entries in the loop buffer memory; and
determining, based on the accessed plurality of loop instructions for the captured loop in the plurality of instruction entries in the loop buffer memory, if the loop optimization is available to be made for the captured loop;
modifying at least one instruction entry among the plurality of instruction entries in the loop buffer memory for the captured loop to produce the optimized loop, in response to determining the loop optimization is available to be made for the captured loop; and
inserting the optimized loop from the loop buffer memory in the instruction pipeline to be replayed, in response to determining the captured loop is to be replayed in the instruction pipeline.

22. The method of claim 20, wherein:
determining if the loop optimization is available to be made for the captured loop, based on the captured loop comprises:
determining if at least one loop instruction among the plurality of loop instructions in the captured loop can be transformed while maintaining the same function of the at least one loop instruction when executed; and
modifying at least one instruction entry among the plurality of instruction entries in the loop buffer memory for the captured loop to produce the optimized loop comprises transforming the at least one loop instruction among the plurality of loop instructions in the captured loop to produce the optimized loop, in response to determining the at least one loop instruction among the plurality of loop instructions in the captured loop can be transformed while maintaining the same function of the at least one loop instruction when executed.

23. The method of claim 22, wherein:
determining if the at least one loop instruction among the plurality of loop instructions in the captured loop can be transformed comprises determining if at least two loop instructions among the plurality of loop instructions in the captured loop can be fused into at least one fused instruction that has the same function of the at least two loop instructions when executed; and
transforming the at least one loop instruction among the plurality of loop instructions in the captured loop to produce the optimized loop comprises fusing the at least two loop instructions among the plurality of loop instructions in the captured loop to produce the optimized loop, in response to determining the at least two loop instructions among the plurality of loop instructions can be fused into the at least one fused instruction that has the same function of the at least two loop instructions when executed.

24. The method of claim 22, wherein:
determining if the at least one loop instruction among the plurality of loop instructions in the captured loop can be transformed comprises determining if at least one loop instruction among the plurality of loop instructions in the captured loop can be fused with itself in the captured loop when the captured loop is executed in at least one subsequent iteration of the captured loop; and
transforming the at least one loop instruction among the plurality of loop instructions in the captured loop to produce the optimized loop comprises identifying the at least one loop instruction among the plurality of loop instructions in the captured loop to not be replayed on at least one subsequent iteration of the execution of captured loop to produce the optimized loop, in response to determining the at least one loop instruction among the plurality of loop instructions in the captured loop can be fused with itself in the captured loop when the captured loop is executed in at least one subsequent iteration of the captured loop.

25. The method of claim 22, wherein:
determining if the at least one loop instruction among the plurality of loop instructions in the captured loop can be transformed comprises determining if the at least one loop instruction among the plurality of loop instructions in the captured loop is loop invariant to the captured loop; and
transforming the at least one loop instruction among the plurality of loop instructions in the captured loop to produce the optimized loop comprises removing the at least one loop instruction among the plurality of loop instructions determined to be loop invariant from the captured loop to produce the optimized loop, in response to determining the at least one loop instruction among the plurality of loop instructions in the captured loop is loop invariant to the captured loop.

26. The method of claim 22, wherein:
determining if the at least one loop instruction among the plurality of loop instructions in the captured loop can be transformed comprises determining if the at least one loop instruction among the plurality of loop instructions in the captured loop can be modified to at least one alternative instruction with the same function as the at least one loop instruction and executed in less clock cycles than the at least one loop instruction; and
transforming the at least one loop instruction among the plurality of loop instructions in the captured loop to produce the optimized loop comprises transforming the at least one loop instruction among the plurality of loop instructions in the captured loop to the at least one alternative instruction to produce the optimized loop, in response to determining the at least one loop instruction among the plurality of loop instructions in the captured loop can be modified to at least one alternative instruction with the same function as the at least one loop instruction and can be executed in less clock cycles than the at least one loop instruction.

27. The method of claim 22, wherein the loop buffer circuit is configured to:
determining if the at least one loop instruction among the plurality of loop instructions in the captured loop can be transformed comprises determining if the at least one loop instruction among the plurality the loop instructions in the captured loop is a critical instruction; and
transforming the at least one loop instruction among the plurality of loop instructions in the captured loop to produce the optimized loop comprises setting a scheduling priority indicator associated with the critical instruction to cause the critical instruction to be scheduled for execution at a higher priority in the instruction pipeline when the optimized loop is inserted in the instruction pipeline to be replayed as the optimized loop, in response to determining the at least one loop instruction among the plurality of loop instructions in the captured loop is a critical instruction.

28. The method of claim 20, wherein:
determining if the loop optimization is available to be made for the captured loop, based on the captured loop comprises determining if an instruction execution slice is present among the plurality of loop instructions in the captured loop;
modifying the captured loop to produce the optimized loop comprises identifying the instruction execution slice among the plurality of loop instructions in the captured loop, in response to determining the instruction execution slice is present among the plurality of loop instructions in the captured loop; and
in response to determining the captured loop is to be replayed in the instruction pipeline, inserting the optimized loop in the instruction pipeline to be replayed by:
creating at least one pre-fetch instruction representing the identified instruction execution slice in the captured loop;
inserting the at least one pre-fetch instruction in a pre-fetch stage in the instruction pipeline to be executed; and
inserting the other plurality of instructions in optimized loop not identified as the instruction execution slice in the instruction pipeline to be executed.

29. The method of claim 28, wherein:
determining if the captured loop is to be replayed in the instruction pipeline comprises determining if the captured loop is to be replayed in the instruction pipeline in a regular replay mode; and
comprising inserting the optimized loop in the instruction pipeline to be replayed, in response to determining the captured loop is to be replayed in the instruction pipeline in the regular replay mode.

30. A non-transitory computer-readable medium having stored thereon computer executable instructions which, when executed by a processor, cause the processor to replay an optimized loop based on a captured loop in an instruction pipeline in a processor, by causing the processor to:
detect a loop comprising a plurality of loop instructions among the plurality of instructions in an instruction stream comprising a plurality of instructions in an instruction pipeline;
in response to detection of the loop in the instruction stream:
capture the plurality of loop instructions of the detected loop as a captured loop;
determine, based on the captured loop, if a loop optimization is available to be made for the captured loop; and
modify the captured loop to produce an optimized loop, in response to determining the loop optimization is available to be made for the captured loop;
determine if the captured loop is to be replayed in the instruction pipeline; and
insert the optimized loop in the instruction pipeline to be replayed, in response to determining the captured loop is to be replayed in the instruction pipeline.
